(19) United States
(12) Patent Application Publication
(10) Pub. No.: US 2006/0099411 A1
(43) Pub. Date: May 11, 2006

(54) Multi-layer pressure sensitive adhesive for optical assembly

(76) Inventors: Jianhui Xia, Woodbury, MN (US); Ying-Yuh Lu, Woodbury, MN (US); Richard Charles Allen, Lilydale, MN (US)

Correspondence Address: 3M INNOVATIVE PROPERTIES COMPANY, PO BOX 33427, ST. PAUL, MN, 55133-3427, US

(21) Appl. No.: 10/985,380

(22) Filed: Nov. 10, 2004

(51) Int. Cl. B32B 7/12; B32B 15/04

(52) U.S. Cl. 428/343; 428/354

(57) ABSTRACT

An optical film is described as including a polyolefin film, a first pressure sensitive adhesive layer disposed on the polyolefin film having a 180 degree peel adhesion value to the polyolefin film, and a second pressure sensitive adhesive layer having a 180 degree peel adhesion value to glass. The first pressure sensitive adhesive layer is disposed between the second pressure sensitive layer and the polyolefin film and the 180 degree peel adhesion value to the polyolefin film is 50% greater than the 180 degree peel adhesion value to glass. Methods for forming optical film and optical elements are also described, as well as methods for removing such optical films from glass.

### BACKGROUND

The present disclosure generally relates to multi-layer pressure sensitive adhesives (PSA) for use in optical assembly. The present disclosure more particularly relates to multi-layer PSA for use with optical films.

Optical films can be coupled to optical elements, such as liquid crystal cells of liquid crystal display devices (LCDs). Pressure sensitive adhesives have been used to adhere optical films onto glass elements such as liquid crystal display (LCD) cells. With the increased use of LCDs in various fields, such as in electronic watches, televisions, equipment for loading in cars, etc., and in particular, with the recent increase of the performance, size and cost of LCDs, it has been considered beneficial that the pressure sensitive adhesives (PSAs) have improved removability, i.e., the optical film and the PSA can be cleanly removable from the LCD surface without a significant amount of adhesive residue remaining on the LCD surface. If the PSA can be cleanly removed, the LCD can be saved for reworking, as desired. In addition, the optical films and the PSAs should have improved heat resistance and moisture resistance. In particular, the optical film and PSA should not peel, bubble or distort even in a high-temperature and high-humidity atmosphere. However, polyolefin optical films and PSAs have poor removability from glass due to, at least in part, differences in polarity of the optical film and the glass surfaces. The PSAs tend to stay on the LCD glass surface upon removal of the optical film, after heating, resulting in poor reworkability. Also, when they are used in a high-temperature and high-humidity atmosphere, peeling and/or bubbling typically occurs at, for example, the interface between the PSA and the LCD surface, leading to a decrease in optical properties of the display.

### SUMMARY

Generally, the present disclosure relates to multi-layer PSA for optical assemblies useful for a variety of applications including, for example, optical film for displays, such as liquid crystal displays, as well as the displays and other devices containing the optical film.

In one embodiment, an optical film includes a polyolefin film, a first pressure sensitive adhesive layer disposed on the polyolefin film having a 180 degree peel adhesion value to the polyolefin film, and a second pressure sensitive adhesive layer having a 180 degree peel adhesion value to glass. The first pressure sensitive adhesive layer is disposed between the second pressure sensitive layer and the polyolefin film and the 180 degree peel adhesion value to the polyolefin film is 50% greater than the 180 degree peel adhesion value of the second pressure sensitive adhesive to glass.

In a further embodiment, an optical element includes a polyolefin film, a first pressure sensitive adhesive layer disposed on the polyolefin film having a 180 degree peel adhesion value to the polyolefin film, a second pressure sensitive adhesive layer having a 180 degree peel adhesion value to glass, and a substrate disposed on the second pressure sensitive adhesive layer. The first pressure sensitive adhesive layer is disposed between the second pressure sensitive layer and the polyolefin film and the 180 degree peel adhesion value to the polyolefin film is 50% greater than the 180 degree peel adhesion value to glass.

In another embodiment, a method of forming an optical film includes steps of disposing a first pressure sensitive adhesive layer adjacent a second pressure sensitive adhesive layer to form a multi-layer pressure sensitive adhesive, and disposing the multi-layer pressure sensitive adhesive on a polyolefin film such that the first pressure sensitive adhesive layer is disposed between the second pressure sensitive adhesive layer and the polyolefin film. The first pressure sensitive adhesive layer has a 180 degree peel adhesion value to the polyolefin film and the second pressure sensitive layer has a 180 degree peel adhesion value to glass. The 180 degree peel adhesion value to the polyolefin film is 50% greater than the 180 degree peel adhesion value to glass.

In still a further embodiment, the present disclosure is directed to a method of removing from a glass substrate an optical film including a polyolefin film, a first pressure sensitive adhesive layer having a 180 degree peel adhesion value to the polyolefin film and a second pressure sensitive adhesive layer having a 180 degree peel adhesion value to glass. The first pressure sensitive adhesive layer is disposed between the second pressure sensitive layer and the polyolefin film, the second pressure sensitive adhesive layer is disposed between the first pressure sensitive adhesive layer and glass, and the 180 degree peel adhesion value to the polyolefin film is 50% greater than the 180 degree peel adhesion value to glass. The method includes the step of removing the optical film from the glass substrate without transferring any of the second pressure sensitive adhesive layer to the glass substrate.

The above summary of the present disclosure is not intended to describe each disclosed embodiment or every implementation of the present disclosure. The Figures, Detailed Description and Examples which follow more particularly exemplify these embodiments.

### BRIEF DESCRIPTION OF THE DRAWINGS

The disclosure may be more completely understood in consideration of the following detailed description of various embodiments of the present disclosure in connection with the accompanying drawings, in which:

FIG. 1 is a schematic illustration of a coordinate system with an optical film element; and

FIG. 2 is a schematic cross-sectional view of an optical element according to an embodiment of the disclosure.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

The present disclosure provides a pressure sensitive adhesive that can be used to adhere polyolefin optical films onto glass elements such as, for example, glass substrates commonly used in LCDs, with the ability to cleanly remove the optical film and PSA and having a relatively high temperature and relatively high humidity stability.

The optical film including a multi-layer PSA of the present disclosure is believed to be applicable to a variety of applications needing polymeric optical film including, for example, optical displays, such as liquid crystal displays, as well as the displays and other devices containing the optical film. While the present disclosure is not so limited, an appreciation of various aspects of the disclosure will be gained through a discussion of the examples provided below.

For the following defined terms, these definitions shall be applied, unless a different definition is given in the claims or elsewhere in this specification.

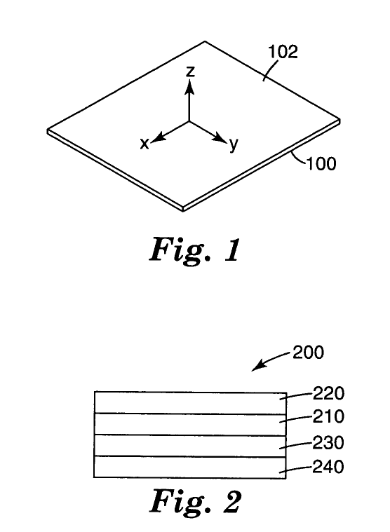

A “c-plate” denotes a birefringent optical element, such as, for example, a plate or film, with a principle optical axis (often referred to as the “extraordinary axis”) substantially perpendicular to the selected surface of the optical element. The principle optical axis corresponds to the axis along which the birefringent optical element has an index of refraction different from the substantially uniform index of refraction along directions normal to the principle optical axis. As one example of a c-plate, using the axis system illustrated in FIG. 1, nₓ=n_{y}≠n_{z}, where nₓ, n_{y}, and n_{z} are the indices of refraction along the x, y, and z axes, respectively. The optical anisotropy is defined as Δn_{zx}=n_{z}−nₓ. For purposes of simplicity, Δn_{zx} will be reported as its absolute value, although one skilled in the art recognizes that the sign, positive or negative, of the difference (n_{z}−nₓ) is an important parameter.

A “biaxial retarder” denotes a birefringent optical element, such as, for example, a plate or film, having different indices of refraction along all three axes (i.e., nₓ≠n_{y}≠n_{z}). Biaxial retarders can be fabricated, for example, by biaxially orienting plastic films. Examples of biaxial retarders are discussed in U.S. Pat. No. 5,245,456, incorporated herein by reference. Examples of suitable films include films available from Sumitomo Chemical Co. (Osaka, Japan) and Nitto Denko Co. (Osaka, Japan). In-plane retardation and out of plane retardation are parameters used to describe a biaxial retarder. As the in-plane retardation approaches zero, the biaxial retarder element behaves more like a c-plate. Generally, a biaxial retarder, as defined herein, has an in-plane retardation of at least 3 nm for 550 nm light. Retarders with lower in-plane retardation are considered c-plates.

The term “polymer” will be understood to include polymers, copolymers (e.g., polymers formed using two or more different monomers), oligomers and combinations thereof, as well as polymers, oligomers, or copolymers that can be formed in a miscible blend by, for example, coextrusion or reaction, including transesterification. Both block and random copolymers are included, unless indicated otherwise.

The term “polarization” refers to plane polarization, circular polarization, elliptical polarization, or any other nonrandom polarization state in which the electric vector of the beam of light does not change direction randomly, but either maintains a constant orientation or varies in a systematic manner. In plane polarization, the electric vector remains in a single plane, while in circular or elliptical polarization, the electric vector of the beam of light rotates in a systematic manner.

The term “biaxially stretched” refers to a film that has been stretched in two different directions, a first direction and a second direction, in the plane of the film.

The term “simultaneously biaxially stretched” refers to a film in which at least a portion of stretching in each of the two directions is performed substantially simultaneously.

The terms “orient,” “draw,” and “stretch” are used interchangeably throughout this disclosure, as are the terms “oriented,” “drawn,” and “stretched” and the terms “orienting,” “drawing,” and “stretching”.

The term “retardation or retardance” refers to the difference between two orthogonal indices of refraction times the thickness of the optical element.

The term “in-plane retardation” refers to the product of the difference between two orthogonal in-plane indices of refraction times the thickness of the optical element.

The term “out-of-plane retardation” refers to the product of the difference of the index of refraction along the thickness direction (z direction) of the optical element minus one in-plane index of refraction times the thickness of the optical element. Alternatively, this term refers to the product of the difference of the index of refraction along the thickness direction (z direction) of the optical element minus the average of two orthogonal in-plane indices of refraction times the thickness of the optical element. It is understood that the sign, positive or negative, of the out-of-plane retardation is important to the user. But for purposes of simplicity, generally only the absolute value of the out-of-plane retardation will be reported herein. It is understood that one skilled in the art will know when to use an optical device whose out-of-plane retardation is appropriately positive or negative. For example, it is generally understood that an oriented film comprising poly(ethylene terephthalate) will produce a negative c-plate, when the in-plane indices of refraction are substantially equal and the index of refraction in the thickness direction is less than the in-plane indices. But as described herein, the value of the out-of-plane retardation will be reported as a positive number.

The term “substantially non-absorbing” refers to the level of transmission of the optical element, being at least 80 percent transmissive to at least one polarization state of visible light, where the percent transmission is normalized to the intensity of the incident, optionally polarized light.

The term “substantially non-scattering” refers to the level of collimated or nearly collimated incident light that is transmitted through the optical element, being at least 80 percent transmissive for at least one polarization state of visible light within a cone angle of less than 30 degrees.

The term “adjacent” refers to an element being near or close to another element. A first layer being adjacent a second layer includes the first layer being disposed on the second layer and further includes the first layer separated form the second layer by one or more intermediate layers.

Unless otherwise indicated, all numbers expressing feature sizes, quantities of ingredients, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present disclosure.

Weight percent, percent by weight, % by weight, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” include plural referents unless the content clearly dictates otherwise. Thus, for example, reference to a composition containing “an adhesive layer” includes two or more adhesive layers. As used in this specification and the appended claims, the term “or” is generally employed in its sense including “and/or” unless the content clearly dictates otherwise.

FIG. 1 is a schematic illustration of a coordinate system with an optical film element. Generally, for display devices, the x and y axes correspond to the width and length of the display and the z axis is typically along the thickness direction of the display. This convention will be used throughout, unless otherwise stated. In the axis system of FIG. 1, the x axis and y axis are defined to be parallel to a major surface 102 of the optical element 100 and may correspond to width and length directions of a square or rectangular surface. The z axis is perpendicular to that major surface and is typically along the thickness direction of the optical element.

Pressure sensitive adhesives can be used to adhere optical film to other optical elements such as glass substrates, for example, glass substrates found in liquid crystal displays (LCDs). It is often desirable to cleanly remove the PSA with its attached optical film from LCD glass with low force if lamination defects are present in the LCD display at any point during manufacture. A cleanly removable PSA can be termed a “re-workable” PSA. In addition, LCD displays with re-workable PSA needs to pass environmental stability tests (e.g., 80° C. and 60° C. at 90% relative humidity) without delamination of the optical film from the bonded glass substrate and/or bubbling in the PSA at the interface of the PSA and the substrate.

Generally, this disclosure describes a multi-layer PSA that is re-workable PSA for attaching polyolefin films to glass substrates such as, for example, LCD cells. This multi-layer PSA includes a higher adhesion PSA that adheres to polyolefin film and a lower adhesion PSA that adheres to glass substrates.

FIG. 2 is a schematic cross-sectional view of an optical element 200 according to an embodiment of the present disclosure. The optical element 200 can include an optical film 220 and a first pressure sensitive adhesive layer 210 disposed on the optical film 220. The first pressure sensitive adhesive layer 210 has a 180 degree peel adhesion value to the optical film 220. The 180 degree peel adhesion values are measured according to the methods defined in the Example section below. A second pressure sensitive adhesive layer 230 is disposed adjacent the first pressure sensitive adhesive layer 210 such that the first pressure sensitive adhesive layer 210 is disposed between the optical film 220 and the second pressure sensitive adhesive layer 230.

In some embodiments, the second pressure sensitive adhesive layer 230 is disposed on and in contact with the first pressure sensitive adhesive layer 210. In further embodiments, the second pressure sensitive adhesive layer 230 is separated from the first pressure sensitive adhesive layer 210 by one or more intermediate layers (not shown.) The one or more intermediate layers can be “tie layer” capable of bonding the second pressure sensitive adhesive layer 230 to the first pressure sensitive adhesive layer 210.

The first pressure sensitive adhesive layer 210 and the second pressure adhesive layer 230 can be formed by any method such as, for example, solution coating or extrusion. In some embodiments, the first pressure sensitive adhesive layer 210 and the second pressure adhesive layer 230 can be formed simultaneously or nearly simultaneously, such that the first pressure sensitive adhesive layer 210 and the second pressure adhesive layer 230 diffuse into each other at an interface between the first pressure sensitive adhesive layer 210 and the second pressure adhesive layer 230. Interlayer diffusion (interdiffusion) between the first pressure sensitive adhesive layer 210 and the second pressure adhesive layer 230 can increase the adhesion strength between the first pressure sensitive adhesive layer 210 and the second pressure adhesive layer 230.

Interdiffusing the first pressure sensitive adhesive layer 210 and the second pressure adhesive layer 230 can be accomplished in a number of ways. In one embodiment, the second pressure sensitive adhesive layer 230 is solution coated onto a substrate such as, for example, a release liner, and the first pressure sensitive adhesive layer 210 is solution coated onto the second pressure sensitive adhesive layer 230 while the second pressure sensitive adhesive layer 230 is still wet. In another embodiment, the first pressure sensitive adhesive layer 210 is solution coated onto a release liner and the second pressure sensitive adhesive layer 230 is solution coated onto the first pressure sensitive adhesive layer 210 while the first pressure sensitive adhesive layer 210 is still wet. The first pressure sensitive adhesive layer 210 and the second pressure sensitive adhesive layer 230 can be formed of compatible or similar materials such as, for example, polyacrylates. In some embodiments, these compatible or similar materials can diffuse or migrate between the layers 210 and 230 allowing polymer chains to become entangled. In further embodiments, a cross-linking agent or material can be included in either or both of the first pressure sensitive adhesive layer 210 or the second pressure sensitive adhesive layer 230. Thus, this cross-linking agent or material can cross-link the first layer 210 and second layer 230 polymers, increasing interlayer adhesion.

The first pressure sensitive adhesive layer 210 can have any useful thickness such as, for example, 5 to 100 micrometers, or 5 to 50 micrometers, or 5 to 25 micrometers. The second pressure sensitive adhesive layer 230 can have any useful thickness such as, for example, 5 to 100 micrometers, or 5 to 50 micrometers, or 5 to 25 micrometers. The total thickness of the first pressure sensitive adhesive layer 210 and the second pressure sensitive adhesive layer 230 can be any useful thickness such as, for example, 5 to 100 micrometers, or 10 to 75 micrometers, 10 to 50 micrometers, or 15 to 40 micrometers. Other values and ranges of the first, second and total thicknesses may be used as desired for a particular application.

The second pressure sensitive adhesive layer 230 can be disposed on a substrate 240. The substrate 240 can be a release layer or an element of an optical display, such as a glass substrate. In some embodiments, the second pressure sensitive layer 230 can be formed on the release layer 240. The release layer 240 can be removed from the second pressure sensitive layer 230 and then the second pressure sensitive layer 230 can be disposed on a glass substrate of an element of an optical display such as, for example, a liquid crystal display.

The second pressure sensitive layer 230 has a 180 degree peel adhesion value to the glass substrate 240. In some embodiments, this 180 degree peel adhesion value to the glass substrate 240 is 65% or less, or 50% or less, or 25% or less than both the 180 degree adhesion peel values of the first pressure sensitive adhesive layer to the optical film and the first pressure sensitive adhesive layer to the second pressure adhesive layer. In further embodiments, the first pressure sensitive adhesive layer 180 degree peel adhesion value to the polyolefin film is 50% or greater, 75% or greater, 100% or greater, 150% or greater, or 200% or greater than the second pressure sensitive adhesive layer 180 degree peel adhesion value to glass. Percent greater peel adhesion is defined as:

$$\frac{( \begin{matrix}Peel adhesion to polyolefin film value - \\ Peel adhesion to glass value\end{matrix} )}{Peel adhesion to glass value} \times 100$$

The 180 degree peel adhesion values are measured according to the methods defined in the Example section below.

In illustrative embodiments, the first pressure sensitive adhesive has a 180 degree peel value to the optical film of 25 oz/in or greater, or in a range of 25 to 100 oz/in and the second pressure sensitive adhesive has a 180 degree peel value to glass of 15 oz/in or less, or in a range of 5 to 15 oz/in. Generally, the 180 degree peel value to the optical film should be sufficient for the optical film to remain adhered to the first pressure sensitive adhesive without delamination during use, while the 180 degree peel value to glass should be low enough for the second pressure sensitive adhesive to be cleanly removed from a glass substrate, without a significant amount of adhesive residue remaining on the glass, and preferably without any adhesive residue remaining on the glass.

A variety of materials and methods can be used to make the optical film elements described herein. The optical film 220 can be, for example, an optical compensation film. In one embodiment, the optical film is a “c-plate.” In another embodiment, the optical film is a “biaxial retarder.”

In some embodiments, the optical film is a uniaxially stretched polymeric film. In other embodiments, the optical film is a simultaneously biaxially stretched polymeric film. The optical film can be substantially non-absorbing and non-scattering for at least one polarization state of visible light. In some embodiments, the optical film can have an x, y, and z orthogonal indices of refraction where at least two of the orthogonal indices of refraction are not equal. In still other embodiments, the optical film can have an x, y, and z orthogonal indices of refraction where at least two of the orthogonal indices of refraction are not equal and further having an in-plane retardance being 100 nm or less and an absolute value of an out-of-plane retardance being 50 or 55 nm or greater.

Any polymeric material capable of possessing the optical properties described herein or other useful properties are contemplated. A partial listing of these polymers include, for example, polyolefins, polyacrylates, polyesters, polycarbonates, fluoropolymers and the like. One or more polymers can be combined to form the polymeric optical film.

Polyolefins include for example: cyclic olefin polymers such as, for example, polycyclohexane, polynorbornene and the like; polypropylene; polyethylene; polybutylene; polypentylene; and the like. A specific polybutylene is poly(1-butene). A specific polypentylene is poly(4-methyl-1-pentene). The polymeric material described herein can be capable of forming a crystalline or semi-crystalline material. The polymeric material described herein may also be capable of forming a non-crystalline material.

Polyesters can include, for example, poly(ethylene terephthalate) or poly(ethylene naphthalate). The polymeric material described herein can be capable of forming a crystalline or semi-crystalline material. The polymeric material described herein may also be capable of forming a non-crystalline material.

Polyacrylate includes, for example, acrylates, methacrylates and the like. Examples of specific polyacrylates include poly(methyl methacrylate), and poly(butyl methacrylate).

Fluoropolymer specifically includes, but is not limited to, poly(vinylidene fluoride).

In some embodiments, the in-plane retardance of the polymeric optical film may be 100 nm or less or 0 nm to 100 nm. The in-plane retardance of the polymeric optical film may be 20 nm or less or 0 nm to 20 nm. The in-plane retardance of the polymeric optical film may be 20 nm to 50 nm. The in-plane retardance of the polymeric optical film may be 50 nm to 100 nm. In a further illustrative embodiment, the in-plane retardance of the polymeric optical film may be 85 nm or less, or 0 nm to 85 nm. The in-plane retardance of the polymeric optical film may be 50 nm or less, or 0 nm to 50 nm. The in-plane retardance of the polymeric optical film may be 50 nm to 85 mn.

In some embodiments, the absolute value of the out-of-plane retardance of the polymeric optical film may be 50 nm or greater, up to 1000 nm. The absolute value of the out-of-plane retardance of the polymeric optical film may be 75 nm or greater or 75 nm to 1000 nm. The absolute value of the out-of-plane retardance of the polymeric optical film may be 100 nm or greater or 100 nm to 1000 nm. The absolute value of the out-of-plane retardance of the polymeric optical film may be 150 nm or greater or 150 nm to 1000 nm. In a further illustrative embodiment, the absolute value of the out-of-plane retardance of the polymeric optical film may be 55 nm or greater, up to 1000 nm. The absolute value of the out-of-plane retardance of the polymeric optical film may be 200 nm or greater, up to 1000 nm. The absolute value of the out-of-plane retardance of the polymeric optical film may be 225 nm or greater, up to 1000 nm. The absolute value of the out-of-plane retardance of the polymeric optical film may be 400 nm or greater, up to 1000 nm.

The polymeric optical film can have a thickness (z direction) of 3 micrometers or greater. In some exemplary embodiments, the polymeric optical film can have a thickness (z direction) of 3 micrometers to 200 micrometers or 3 micrometers to 100 micrometers. The polymeric optical film can have a thickness (z direction) of 7 micrometers to 75 micrometers. The polymeric optical film can have a thickness (z direction) of 10 micrometers to 50 micrometers. In a further illustrative embodiment, the polymeric optical film can have a thickness (z direction) of 15 micrometers to 40 micrometers. The polymeric optical film can have a thickness (z direction) of 15 micrometers to 25 micrometers. The polymeric optical film can have a thickness (z direction) of 15 micrometers to 20 micrometers. The polymeric optical film can have a thickness (z direction) of 30 micrometers to 40 micrometers. The polymeric optical film can have a thickness (z direction) of 1 micrometer to 10 micrometers. In other exemplary embodiments, the polymeric optical film can have a thickness (z direction) of 1 micrometer to 5 micrometers.

One illustrative embodiment of polymeric optical film includes a film having a thickness from 15 micrometers to 40 micrometers, an in-plane retardance of 85 nm or less, and an absolute value of an out-of-plane retardance of 150 nm or greater. Another embodiment includes a polymeric optical film having a thickness from 15 micrometers to 25 micrometers, an in-plane retardance of 85 nm or less, and an absolute value of an out-of-plane retardance of 200 nm or greater. Another embodiment includes a polymeric optical film having a thickness from 15 micrometers to 20 micrometers, an in-plane retardance of 85 nm or less, and an absolute value of an out-of-plane retardance of 200 nm or greater. Another embodiment includes a polymeric optical film having a thickness from 15 micrometers to 40 micrometers, an in-plane retardance of 100 nm or less, and an absolute value of an out-of-plane retardance of 250 nm or greater. Another embodiment includes a polymeric optical film having a thickness from 15 micrometers to 40 micrometers, an in-plane retardance of 85 nm or less, and an absolute value of an out-of-plane retardance of 300 nm or greater. Another embodiment includes a polymeric optical film having a thickness from 40 micrometers to 60 micrometers, an in-plane retardance of 100 nm or less, and an absolute value of an out-of-plane retardance of 250 nm or greater. Another embodiment includes a polymeric optical film having a thickness from 15 micrometers to 40 micrometers, an in-plane retardance of 100 nm or less, and an absolute value of an out-of-plane retardance of 400 nm or greater. Another embodiment includes a polymeric optical film having a thickness from 1 micrometer to 5 micrometers, an in-plane retardance of 20 nm or less, and an absolute value of an out-of-plane retardance of 300 nm or greater. Another embodiment includes a polymeric optical film having a thickness from 15 micrometers to 20 micrometers, an in-plane retardance of 20 nm or less, and an absolute value of an out-of-plane retardance of 100 nm or greater.

Crystallization modifiers include, for example, clarifying agents and nucleating agents. Crystallization modifiers aid in reducing “haze” in the biaxially stretched polymeric optical film. Crystallization modifiers can be present in the polymeric optical film in any amount effective to reduce “haze”, such as, for example, 10 ppm to 500,000 ppm or 100 ppm to 400,000 ppm or 100 ppm to 350000 ppm or 250 ppm to 300,000 ppm.

New techniques for manufacturing polymeric optical film have been developed and disclosed in U.S. Patent Application Publication US 2004/0184150, which is incorporated by reference herein to the extent it does not conflict with this disclosure. These techniques include stretching a polymer film in a first direction and stretching the polymer film in a second direction different than the first direction forming a biaxially stretched polymeric film. At least a portion of the stretching in the second direction occurs simultaneously with the stretching in the first direction. This technique can form a polymeric optical film with the properties and attributes described above.

In some embodiments, the first and second pressure sensitive adhesive layers 210 and 230 include polyacrylate pressure sensitive adhesives. As described above, the first pressure sensitive adhesive layer 210 can posses a relatively high 180 degree peel adhesion value to the optical film, for example, polyolefin film and the second pressure sensitive adhesive layer 230 can posses a relatively low 180 degree peel adhesion value to glass, such that the optical film can be laminated to a glass substrate 240 and subsequently removed from the glass substrate without transferring any of the first and/or second pressure sensitive adhesive layer 210 and/or 230 to the glass substrate 240. In some embodiments, the optical film with the first and second adhesive layers 210, 230 can be laminated to a glass substrate 240 and subjected to an autoclave process. After autoclaving, the optical film and with the first and second adhesive layers 210, 230 can be removed from the glass substrate 240 without transferring any of the first and/or second pressure sensitive adhesive layer 210 and/or 230 to the glass substrate 240. Autoclaving is defined herein as applying heat and pressure to and article. In one embodiment, an autoclaving step includes heating a composite adhesive film element to a temperature of at least 60 degrees Celsius at a pressure of at least 5 atm for at least 30 minutes.

In some embodiments, the optical film 220 includes a corona surface treatment. In other embodiments, the optical film 220 does not include a chemical priming surface treatment.

The Pressure-Sensitive Tape Council (Test Methods for Pressure Sensitive Adhesive Tapes (1994), Pressure Sensitive Tape Council, Chicago, Ill.) has defined pressure sensitive adhesives (PSAs) as material with the following properties: (1) aggressive and permanent tack, (2) adherence with no more than finger pressure, (3) sufficient ability to hold onto an adherand, (4) sufficient cohesive strength, and (5) requires no activation by an energy source. PSAs are normally tacky at assembly temperatures, which is generally room temperature or greater (i.e., about 20° C. to about 30° C. or greater). Materials that function well as PSAs are polymers designed and formulated to exhibit the requisite viscoelastic properties resulting in a desired balance of tack, peel adhesion, and shear holding power at the assembly temperature. Polymers used for preparing PSAs are natural rubber-, synthetic rubber- (e.g., styrene/butadiene copolymers (SBR) and styrene/isoprene/styrene (SIS) block copolymers), silicone elastomer-, poly alpha-olefin-, and various (meth) acrylate- (e.g., acrylate and methacrylate) based polymers (Handbook of Pressure Sensitive Adhesive Technology, 2nd Edition, Edited by D. Satas, 1989). Of these, (meth)acrylate-based polymer PSAs are an example of one preferred class of PSA for the present disclosure due to their optical clarity, permanence of properties over time (aging stability), and versatility of adhesion levels, to name just a few of their benefits. It is known to prepare PSAs comprising mixtures of certain (meth)acrylate- based polymers with certain other types of polymers (Handbook of Pressure Sensitive Adhesive Technology, 2nd Edition, Edited by D. Satas, page 396, 1989). Suitable (meth)acrylate pressure sensitive adhesives include, but not limited to, Soken 1885, 2092, 2137 PSAs (commercially available from Soken Chemical & Engineering Co., Ltd, Japan) and the PSAs described in the U.S. Patent Application Publication US2004/0208709.

Examples of useful (meth)acrylate monomers for preparing a poly(meth)acrylate pressure sensitive adhesives with different viscoelastic and adhesive properties include for example, the following classes:

Class A—includes acrylic acid esters of an alkyl alcohol (preferably a non-tertiary alcohol), the alcohol containing from 1 to 14 (preferably from 4 to 10) carbon atoms and include, for example, sec-butyl acrylate, n-butyl acrylate, isoamyl acrylate, 2-methylbutyl acrylate, 4-methyl-2-pentyl acrylate, 2-ethylhexyl acrylate, isooctyl acrylate, isononyl acrylate, isodecyl methacrylate, dodecyl acrylate, tetradecyl acrylate and mixtures thereof. Of these, isooctyl acrylate, n-butyl acrylate and 2-ethylhexyl acrylate can be preferred. As homopolymers, these (meth)acrylate esters generally have glass transition temperatures (Tg) of below about −20 degree Celsius.

Class B—includes (meth)acrylate or other vinyl monomers which, as homopolymers, have glass transition temperatures of greater than about −20 degrees Celsius, for example, methyl (meth)acrylate, ethyl (meth)acrylate, isopropyl (meth)acrylate, tert-butyl acrylate, isobomyl (meth)acrylate, butyl methacrylate, vinyl acetate, vinyl esters, acrylonitrile, and the like, may be used in conjunction with one or more other (meth)acrylate monomers, preferably to provide a polymer having a glass transition temperature below about 0 degree Celsius, optionally and preferably also to achieve useful pressure sensitive adhesive and optical properties. The class B monomers can be used to vary Tg and modulus of the adhesives.

Class C—includes polar monomers such as (meth)acrylic acid; (meth)acrylamides such as N-alkyl (meth)acrylamides and N,N-dialkyl (meth)acrylamides; hydroxy alkyl (meth)acrylates; and N-vinyl lactams such as N-vinyl pyrrolidone and N-vinyl caprolactam; N,N dimethylaminoethyl (meth)acrylate, N,N diethylaminoethyl (meth)acrylate, and N,N dimethylaminopropyl (meth)acrylate. The polar monomers can be included in the PSA compositions to adjust the Tg or the cohesive strength of the adhesive. Additionally, the polar monomers can function as reactive sites for chemical or ionic crosslinking, if desired.

Class D (Crosslinkers)—In order to increase cohesive strength of the poly(meth)acrylate pressure sensitive adhesives, a crosslinking additive may be incorporated into the PSAs. Two main types of crosslinking additives are commonly used. The first crosslinking additive is a thermal crosslinking additive such as a multifunctional aziridine. One example is 1, I′-(1,3-phenylene dicarbonyl)-bis-(2-methylaziridine) (CAS No. 76522 -64-4), referred to herein as “Bisamide”. Such chemical crosslinkers can be added into solvent-based PSAs after polymerization and activated by heat during oven drying of the coated adhesive. In another embodiment, chemical crosslinkers which rely upon free radicals to carry out the crosslinking reaction may be employed. Reagents such as, for example, peroxides serve as a source of free radicals. When heated sufficiently, these precursors will generate free radicals which bring about a crosslinking reaction of the polymer. One example of a free radical generating reagent is benzoyl peroxide. If present, free radical generators are required only in small quantities, but generally require higher temperatures to complete a crosslinking reaction than those required for the bisamide reagent. The second type of chemical crosslinker is a photosensitive crosslinker which is activated by high intensity ultraviolet (UV) light. Two common photosensitive crosslinkers used for acrylic PSAs are benzophenone and copolymerizable aromatic ketone monomers as described in U.S. Pat. No. 4,737,559. Another photocrosslinker, which can be post-added to the solution polymer and activated by UV light is a triazine, for example, 2,4-bis(trichloromethyl)-6-(4-methoxy-pheynl)-s-triazine. These crosslinkers are activated by UV light generated from artificial sources such as medium pressure mercury lamps or a UV blacklight. Hydrolyzable, free-radically copolymerizable crosslinkers, such as monoethylenic ally unsaturated mono-, di-, and trialkoxy silane compounds including, but not limited to, methacryloxypropyltrimethoxysilane (available from Gelest, Inc., Tullytown, Pa.), vinyl dimethylethoxysilane, vinyl methyl diethoxysi lane, vinyltriethoxysilane, vinyltrimethoxysilane, vinyltriphenoxysilane, and the like, are also useful crosslinking agents. Crosslinking may also be achieved using high energy electromagnetic radiation such as gamma or e-beam radiation. In this case, no crosslinker may be required.

Class E (Additives)—Following copolymerization, other additives may be blended with the resultant poly(meth)acrylate pressure sensitive adhesives. For example, compatible tackifiers and/or plasticizers may be added to aid in optimizing the ultimate modulus, Tg, tack and peel properties of the PSA. The use of such tack-modifiers is described in the Handbook of Pressure-Sensitive Adhesive Technology, edited by Donatas Satas (1982). Examples of useful tackifiers include, but are not limited to, rosin, rosin derivatives, polyterpene resins, coumarone-indene resins, and the like. Plasticizers which may be added to the adhesive of the disclosure may be selected from a wide variety of commercially available materials. In each case, the added plasticizer must be compatible with the PSA. Representative plasticizers include polyoxyethylene aryl ether, dialkyl adipate, 2-ethylhexyl diphenyl phosphate, t-butylphenyl diphenyl phosphate, (2-ethylhexyl) adipate, toluenesulfonamide, dipropylene glycol dibenzoate, polyethylene glycol dibenzoate, polyoxypropylene aryl ether, dibutoxyethoxyethyl formal, and dibutoxyethoxyethyl adipate.

In some embodiments, one or more tackifiers are added to the first pressure sensitive adhesive material to increase adhesion of the first pressure sensitive adhesive layer to the optical film, for example, polyolefin optical film. In other embodiments, one or more plasticizers are added to the first pressure sensitive adhesive material to increase adhesion of the first pressure sensitive adhesive layer to the optical film, for example, polyolefin optical film. In further embodiments one or more tackifiers and one or more plasticizers are added to the first pressure sensitive adhesive material to increase adhesion of the first pressure sensitive adhesive layer to the optical film, for example, polyolefin optical film.

The adhesive properties of pressure sensitive adhesives are to a great extent influenced by their viscoelastic behavior. Dynamic mechanical analysis (DMA) is frequently used to characterize the viscoelastic properties of common polymers. Values of the glass transition temperature (Tg), the storage modulus (G′), and the loss modulus (G′) can be measured through DMA. There are different ways to vary the storage modulus (G′) of an adhesive. For example, higher molecular weight and/or the incorporation of more polar monomers or comonomers with higher Tg of its homopolymer in the polymer leads to an increase of the storage modulus (G′). On the other hand, the use of tackifiers or plasticizers usually decreases the storage modulus (G′). However, modulus itself does not indicate adhesion properties.

The adhesive properties of pressure sensitive adhesives can be measured by standard peel adhesion test that is similar to the test method described in ASTM D 3330-90. The cohesive strength of pressure sensitive adhesives can be measured by test that is similar to the test method described in ASTM D 3654-88. PSAs with low peel adhesions both before and after autoclave treatment (e.g., 60° C. & 5 atm for 30 minutes) are desired for re-workability in display applications. Such PSAs are commercially available from Soken compnay in Japan and include, for example, Soken 2110, Soken 2114, and Soken 2137.

In some embodiments, the first and second pressure sensitive layers 210 and 230 each include a different (meth)acrylate polymer. In other embodiments, the first pressure sensitive layer 210 includes a first (meth)acrylate polymer and a tackifier and the second pressure sensitive layer 230 includes the first (meth)acrylate polymer.

The polymeric optical film with the multi-layer PSA described herein can be used with a variety of other components and films that enhance or provide other properties to a liquid crystal display. Such components and films include, for example, brightness enhancement films, retardation plates including quarter-wave plates and films, multilayer or continuous/disperse phase reflective polarizers, metallized back reflectors, prismatic back reflectors, diffusely reflecting back reflectors, multilayer dielectric back reflectors, and holographic back reflectors.

### EXAMPLES

Materials

SBOPP refers to simultaneous biaxially orientated polypropylene (SBOPP) film (formed as described in U.S. Patent Application Publication US 2004/0184150.)
Soken 2137 refers to a polyacrylate pressure sensitive adhesive solution commercially available from Soken Company, Japan.
Soken 1885 refers to a polyacrylate pressure sensitive adhesive solution commercially available from Soken Company, Japan.
Foral 85 refers to a hydrogenated rosin ester commercially available from Hercules, Inc. Sylvalite RE 80HP refers to a rosin ester commercially available from Arizona Chemical Co., Panama City, Fla.
Schenectady SP-553 refers to a phenolic modified terpene commercially available from Schenectady International, Schenectady, N.Y.
Sylvares TP2019 refers to a phenolic modified terpene commercially available from Arizona Chemical Co., Panama City, Fla.
   Sample Preparation
   Dual-layer adhesives were formed by simultaneous coating two pressure sensitive adhesive solutions (as noted in each example) on to a release liner and then dried. Each adhesive solution was coated using a knife-coater. The dual-layer adhesive was dried at 65 degrees Celsius for 10 minutes to a final combined thickness of 25 micrometers (1 mil.) This dried dual-layer adhesive was laminated to a simultaneous biaxially orientated polypropylene (SBOPP) film (corona treated at 1 J/cm² and formed as described in U.S. Patent Application Publication US 2004/0184150.) Once the dual-layer adhesive is laminated to the SBOPP film, it is allowed to dwell at least 12 hours (at ambient conditions.) FIG. 2 illustrates the sample construction: SBOPP layer 220 (Layer 1), first adhesive layer 210 (Layer 2), second adhesive layer 230 (layer 3), and release or glass layer 240 (Layer 4). The sample (Examples 1-9 and CE1-CE2) is then tested as described below.
   180 Degree Peel Adhesion Test to Polyolefin
   Each sample was laminated to anodized aluminum. An initial adhesion was measured according to the standard test method described in ASTM D3330-90 whereby the dual-layer adhesive completely transfers to the anodized aluminum.
   180 Degree Peel Adhesion Test to Glass
   Each sample was laminated to glass. Initial adhesion was measured according to the standard test method described in ASTM D3330-90.

Examples 1 through 9 and comparative examples 1 and 2 are described in Table 1 below:

TABLE 1

| | | | Layer 2 Dry | | Layer 3 Dry |
|---|---|---|---|---|---|
| | | | Thickness | | Thickness |
| Example | Layer 1 | Layer 2 | (μm) | Layer 3 | (μm) |
| 1 | SBOPP | 75 wt % Soken 2137 | 12 | Soken 2137 | 12 |
| | | 25 wt % Foral 85 | | | |
| 2 | SBOPP | 75 wt % Soken 2137 | 12 | Soken 2137 | 12 |
| | | 25 wt % Sylvalite RE80HP | | | |
| 3 | SBOPP | 75 wt % Soken 2137 | 12 | Soken 2137 | 12 |
| | | 25 wt % Schenectady SP-553 | | | |
| 4 | SBOPP | 75 wt % Soken 2137 | 12 | Soken 2137 | 12 |
| | | 25 wt % Sylvares TP2019 | | | |
| 5 | SBOPP | Soken 1885 | 4 | Soken 2137 | 21 |
| 6 | SBOPP | Soken 1885 | 6 | Soken 2137 | 19 |
| 7 | SBOPP | Soken 1885 | 12 | Soken 2137 | 12 |
| 8 | SBOPP | Soken 1885 | 19 | Soken 2137 | 6 |
| 9 | SBOPP | Soken 1885 | 21 | Soken 2137 | 4 |
| CE1 | SBOPP | Soken 2137 | 12 | Soken 2137 | 12 |
| CE2 | SBOPP | Soken 1885 | 12 | Soken 1885 | 12 |

Examples 1 through 9 and comparative examples 1 and 2 where tested for 180 degree peel adhesive value as described herein. The results are reported in Table 2.

TABLE 2

| | Adhesion to | Adhesion to | |
|---|---|---|---|
| | SBOPP | Glass | |
| | (Layer 1 and | (Layer 3 and | |
| | Layer 2) | Layer 4) | Film Removal from |
| Example | (oz/in) | (oz/in) | Glass Notes |
| 1 | 39.0 | 14.5 | Clean removal |
| 2 | 42.0 | 13.6 | Clean removal |
| 3 | 41.0 | 12.0 | Clean removal |
| 4 | 39.0 | 13.0 | Clean removal |
| 5 | 35.0 | 7.5 | Clean removal |
| 6 | 35.0 | 7.5 | Clean removal |
| 7 | 32.0 | 8.0 | Clean removal |
| 8 | 33.0 | 9.5 | Clean removal |
| 9 | 35.0 | 9.5 | Clean removal |
| CE1 | 13.6 | 9.0 | Some PSA transfer to |
| | | | Glass |
| CE2 | 40.0 | 80.0 | PSA transfer to Glass |

The present disclosure should not be considered limited to the particular examples described above, but rather should be understood to cover all aspects of the disclosure as fairly set out in the attached claims. Various modifications, equivalent processes, as well as numerous structures to which the present disclosure may be applicable will be readily apparent to those of skill in the art to which the present disclosure is directed upon review of the instant specification.

We claim:

1. An optical film comprising:
a polyolefin film;
a first pressure sensitive adhesive layer disposed on the polyolefin film having a 180 degree peel adhesion value to the polyolefin film; and
a second pressure sensitive adhesive layer having a 180 degree peel adhesion value to glass;
wherein the first pressure sensitive adhesive layer is disposed between the second pressure sensitive layer and the polyolefin film and the 180 degree peel adhesion value to the polyolefin film is 50% greater than the 180 degree peel adhesion value to glass.

2. An optical film according to claim 1, wherein the 180 degree peel adhesion value to the polyolefin film is 75% or greater than the 180 degree peel adhesion value to glass.

3. An optical film according to claim 1, wherein the 180 degree peel adhesion value to the polyolefin film is 100% or greater than the 180 degree peel adhesion value to glass.

4. An optical film according to claim 1, wherein the polyolefin film is an optical compensation film.

5. An optical film according to claim 1, wherein the polyolefin film has an x, y, and z orthogonal indices of refraction and at least two of the orthogonal indices of refraction are not equal.

6. An optical film according to claim 1, wherein the polyolefin film has an x, y, and z orthogonal indices of refraction and at least two of the orthogonal indices of refraction are not equal, and having an in-plane retardance being 100 nm or less and an out-of-plane retardance being 50 nm or greater.

7. An optical film according to claim 1, wherein the first pressure sensitive adhesive has a 180 degree peel adhesion value to the polyolefin of 25 oz/in or greater.

8. An optical film according to claim 1, wherein the second pressure sensitive adhesive has a 180 degree peel adhesion value to a glass substrate of 15 oz/in or less.

9. An optical film according to claim 1, wherein the first pressure sensitive adhesive layer 180 degree peel adhesion value to the polyolefin film is in a range of 25 to 100 oz/in.

10. An optical film according to claim 1, wherein the second pressure sensitive adhesive layer 180 degree peel adhesion value to glass is in a range of 5 to 15 oz/in.

11. An optical film according to claim 1, wherein the first pressure sensitive adhesive layer and second pressure sensitive adhesive layer have a total thickness in a range of 10 to 50 micrometers.

12. An optical film according to claim 1, wherein the polyolefin is selected from the group consisting of polypropylene, polycyclohexane, polynorbornene, polyethylene, polybutylene, polypentylene, and mixtures thereof.

13. An optical film according to claim 1, wherein the polyolefin comprises polypropylene.

14. An optical film according to claim 1, wherein the first pressure sensitive adhesive layer comprises a first polyacrylate and the second pressure sensitive adhesive comprises a second polyacrylate, the second polyacrylate being different than the first polyacrylate.

15. An optical film according to claim 1, wherein the first pressure sensitive adhesive layer comprises a first polyacrylate and a tackifier and the second pressure sensitive adhesive comprises the first polyacrylate.

16. An optical film according to claim 1, wherein the first pressure sensitive adhesive layer contacts the second pressure sensitive adhesive layer.

17. An optical film according to claim 16, wherein a portion of the first pressure sensitive adhesive layer is diffused within the second pressure sensitive adhesive layer.

18. An optical element comprising:
a polyolefin film;
a first pressure sensitive adhesive layer disposed on the polyolefin film having a 180 degree peel adhesion value to the polyolefin film;
a second pressure sensitive adhesive layer having a 180 degree peel adhesion value to glass; and
a substrate disposed on the second pressure sensitive adhesive layer;
wherein the first pressure sensitive adhesive layer is disposed between the second pressure sensitive layer and the polyolefin film and the 180 degree peel adhesion value to the polyolefin film is 50% greater than the 180 degree peel adhesion value to glass.

19. An optical element according to claim 18, wherein the substrate comprises glass.

20. An optical element according to claim 19, wherein the glass is an element of a liquid crystal display.

21. An optical element according to claim 18, wherein the substrate comprises a release liner.

22. An optical element according to claim 18, wherein the first pressure sensitive adhesive has a 180 degree peel adhesion value to the polyolefin of 25 oz/in or greater.

23. An optical element according to claim 19, wherein the second pressure sensitive adhesive has a 180 degree peel adhesion value to the glass of 15 oz/in or less.

24. An optical element according to claim 18, wherein the polyolefin film is an optical compensation film.

25. An optical element according to claim 18, wherein the polyolefin film has an x, y, and z orthogonal indices of refraction and at least two of the orthogonal indices of refraction are not equal.

26. An optical element according to claim 18, wherein the polyolefin film has an x, y, and z orthogonal indices of refraction and at least two of the orthogonal indices of refraction are not equal, and having an in-plane retardance being 100 nm or less and an out-of-plane retardance being 50 nm or greater.

27. An optical element according to claim 18, wherein the polyolefin film comprises polypropylene.

28. An optical film according to claim 18, wherein the first pressure sensitive adhesive layer contacts the second pressure sensitive adhesive layer.

29. An optical film according to claim 28, wherein a portion of the first pressure sensitive adhesive layer is diffused within the second pressure sensitive adhesive layer.

30. A method of forming an optical film comprising steps of:
disposing a first pressure sensitive adhesive layer adjacent a second pressure sensitive adhesive layer to form a multi-layer pressure sensitive adhesive; and
disposing the multi-layer pressure sensitive adhesive on a polyolefin film such that the first pressure sensitive adhesive layer is disposed between the second pressure sensitive adhesive layer and the polyolefin film, and the first pressure sensitive adhesive layer has a 180 degree peel adhesion value to the polyolefin film and the second pressure sensitive layer has a 180 degree peel adhesion value to glass;
wherein the 180 degree peel adhesion value to the polyolefin film is 50% greater than the 180 degree peel adhesion value to glass.

31. A method according to claim 30, wherein the disposing a first pressure sensitive adhesive layer step comprises solvent coating the first pressure sensitive adhesive layer and the second pressure sensitive adhesive onto a release liner to form a multi-layer pressure sensitive adhesive.

32. A method according to claim 30, further comprising interdiffusing a portion of the first pressure sensitive adhesive layer into the second pressure sensitive adhesive layer.

33. A method according to claim 30, further comprising biaxially orientating the polyolefin film before the disposing a first pressure sensitive adhesive layer step.

34. A method according to claim 30, further comprising simultaneous biaxially orientating the polyolefin film before the disposing the multi-layer pressure sensitive adhesive layer step.

35. A method according to claim 30, further comprising disposing a glass substrate on the second pressure sensitive adhesive layer.

36. A method of removing from a glass substrate an optical film comprising a polyolefin film, a first pressure sensitive adhesive layer having a 180 degree peel adhesion value to the polyolefin film and a second pressure sensitive adhesive layer having a 180 degree peel adhesion value to glass, wherein the first pressure sensitive adhesive layer is disposed between the second pressure sensitive layer and the polyolefin film, the second pressure sensitive adhesive layer is disposed between the first pressure sensitive adhesive layer and glass, and the 180 degree peel adhesion value to the polyolefin film is 50% greater than the 180 degree peel adhesion value to glass, said method comprising the step of:
removing the optical film from the glass substrate without transferring any of the second pressure sensitive adhesive layer to the glass substrate.

37. A method according to claim 36, further comprising the step of autoclaving the optical film prior to the step of removing the optical film from the glass substrate.

38. A method according to claim 37, wherein the autoclaving step comprises heating the optical film to a temperature of at least 60 degrees Celsius at a pressure of at least 5 atm for at least 30 minutes.
